(19) United States
(12) Patent Application Publication
(10) Pub. No.: US 2011/0046929 A1
(43) Pub. Date: Feb. 24, 2011

(54) Method and apparatus for detecting nonlinear distortion in the vibrational response of a structure for use as an indicator of possible structural damage

(76) Inventor: Paul Henry Bryant, Encinitas, CA (US)

Correspondence Address: Paul Bryant, 146 Honeycomb Court, Encinitas, CA, 92024, US

(21) Appl. No.: 12/856,660

(22) Filed: Aug. 15, 2010

Related U.S. Application Data
(60) Provisional application No. 61/235,311, filed on Aug. 19, 2009.
(60) Provisional application No. 61/303,348, filed on Feb. 11, 2010.

(51) Int. Cl. G06F 17/10

(52) U.S. Cl. 703/2

(57) ABSTRACT

Apparatus and method for analyzing data collected from a physical structure for purposes of damage detection or structural health monitoring. The invention attempts to detect signs of nonlinear distortion, which is known to result from most forms of structural damage. The invention uses generic models that can be adjusted to fit arbitrary data to explore the relationship between data sets collected from different locations on or near the physical structure and to capture and detect nonlinearity with those models when it exists in the structural dynamics.

### CROSS-REFERENCE TO RELATED APPLICATIONS

This patent application claims priority to U.S. Provisional Application No. 61235311, filed Aug. 19, 2009, and U.S. Provisional Application No. 61303348, filed Feb. 11, 2010, both of which are incorporated herein by reference. These applications include the original and the final drafts of a manuscript that has since been published in Physical Review E. The manuscript drafts are prefaced by some additional material that outlines various embodiments.

### FIELD OF THE INVENTION

The present invention is directed generally to methods, apparatuses, and systems for damage detection or structural health monitoring. It applies more particularly to a method and apparatus for detecting damage-induced nonlinearity in structures.

### BACKGROUND OF THE INVENTION

As is well known, damage can result in localized nonlinearity in a structure that is otherwise relatively linear. For example, it has been found that loose connections and cracks in a structure will typically result in a nonlinear response. See e.g., “Using Ambient Vibrations to Detect Loosening of a Composite-to-Metal Bolted Joint in the Presence of Strong Temperature Fluctuations”, by J. M. Nichols et al., Journal of Vibration and Acoustics 2007, vol. 129, pp. 710-717, incorporated herein by reference.

Previous works on detecting the effects of nonlinearity in a structure fall into one of two categories: (1) a known vibrational signal is applied to one location on the structure and then a response is looked for at another location and examined for characteristics of nonlinearity that are associated with the known signal (see e.g. U.S. Pat. Nos. 7,426,447, 6,239,593, 6,343,513 and 6584848); and (2) ambient vibrations from the environment provide stimulation to the structure, and the response from some location is analyzed to look for some characteristic signature of nonlinear behavior (see e.g. U.S. Pat. Nos. 7,363,172 and 6,567,752). The current patent application does not fall into either category, as it involves examining the relationship between signals obtained at more than one location, and fitting generic models to the data to characterize this relationship.

The term nonlinear can be taken to mean that the movement that results from an applied force (or vibration) is not strictly in proportion to that force (or vibration amplitude), but rather depends upon it in some more complicated way. The concept becomes slightly more complex for a structure with a large spacial extent because vibrations take time to propagate through a structure and often can get from one point to another by many different paths. Thus if stochastic (noisy and non-periodic) vibrations are applied at one location, the response at some other location can depend on the complete prior history of the applied wave and will typically not look the same as the applied vibration. The term “memoried” will be used in this application to characterize this type of relationship that involves a prior history and the term “memoryless” for the case where the response depends only on the current state of the applied wave. One can still make a distinction between linear and nonlinear when the dynamics are memoried. For a linear system the response will depend linearly (i.e. proportionally) on each point in the prior history and is characterized by a linear response function that specifies how the proportionality factor varies with the time difference between the present time and particular times in the prior history of the applied vibration. For a more detailed discussion, see for example “Statistical Mechanical Theory of Irreversible Processes I” by R. Kubo, Journal of the Physical Society of Japan, vol. 12, pp. 570-586 (1957), incorporated herein by reference. The term “time invariant” will be used for cases where the structural dynamics is not changing in time. The invention makes use of time invariant memoried models of the structural dynamics and these models can be linear or nonlinear. Because they are time invariant, they will depend on knowledge of an input signal at various time differences relative to the current time but will not depend explicitly on time. Usually one can assume that the level of damage to a structure is varying very slowly in time and will not change much within the time span of a collected data set to be analyzed.

In real systems, measurements normally cannot be made continuously, so instead they are made at discrete times separated by a fixed time-step. The resulting data set is called a time series. The time-step is usually chosen to be small enough to resolve the fastest vibrations that are expected in the system. As the size of time-step is reduced, the amount of data collected will increase and also typically the time required to do calculations with that data. So there are practical reasons not to make the time-step any smaller than necessary to achieve useful results. Each element of a time-series will have an associated time index, usually appearing as an integer subscript of a variable that indicates what time-step it is associated with, e.g. x₁, x₂, x₃ . . . could be a sequence of values of x at consecutive time-steps and having associated time indices 1, 2, 3 . . . . Usually the influence of the past history of the applied signal will diminish with time. When attempting to model the response of the system in this discrete time picture, this means that typically one will limit the number of time-steps into the past that are used in the analysis.

### SUMMARY OF THE INVENTION

The invention is a new apparatus and method for detecting structural damage through the analysis of vibrational data from a structure of interest. It would typically, though not necessarily, be used in situations where it was desired to analyze the response of the structure to ambient vibrations from the environment rather than to a known applied signal. Such vibrations could be caused by things like the wind, cars crossing a bridge, ocean waves, the engine on a ship, an airplane taking off or landing, an earthquake, etc.

The data to be analyzed is typically taken from sensors at number of sites on or near the structure and may measure one or more variables of interest. These include, but are not limited to: strain, acceleration, velocity, position and pressure. The only requirements are that the sensors are sensitive enough and respond quickly enough to capture the structural vibrations. Usually the output of these sensors will be periodically measured and digitized to produce time series. These time series can be stored digitally, e.g. on a computer, and this data can be analyzed to look for evidence of structural damage.

Instead of analyzing data taken from single sites as with previous methods, the method of this invention involves finding and modeling a relationship between data taken from two (or possibly more) sites on a structure of interest, and trying to determine from this modeled relationship whether of not there in a significant level on nonlinear distortion present which could indicate the presence of structural damage. Data from one (or possibly more) of these sites will be used as “targets” and that from the one (or possibly more) others will be used as “inputs”. Note that typically, though not necessarily, none of the available data sets are direct measurements of an applied vibrational input. However, this is not a problem because the method allows any sensor output to be used as a “proxy-input”, on the assumption that it has (at least in part) a memoried linear relationship to the actual applied vibrations. The choice of which sensors to choose for the input and target functions is somewhat arbitrary. Note also that when data from many sensors is available, the analysis can be repeated many times using various combinations of two or more of the sensors each time. When structural damage exists, there may tend to be a correlation between the strength of the nonlinear response and the proximity of the chosen sensors to the site of the structural damage, i.e. this may be of help in localizing any damage that is indicated by the method.

This invention makes use of time-invariant memoried models that may convert one or more input time-series into one or more output time-series and which may depend on some finite number of adjustable coefficients or parameters. The intention is for the model to be sufficiently adjustable and generic that it can be adjusted to fit a wide variety of structures and to correct for changes in the structural dynamics that may occur due to structural damage. These models may in some cases have internal structure and may, during the process of evaluating the output time series, generate one or more internal time series. These models may also include “feedback” structure, as a result of which the evaluation of the current output element may depend on prior output values. This may also occur for evaluation of the current value of internal structure variables when they exist. In some embodiments, the model is produced in both a linear form and a nonlinear form with the intention that an improvement in performance of the nonlinear model relative to the linear one indicates the presence of nonlinear distortion which might be caused by structural damage. In some embodiments the two models are partially related in that one may be produced from the other by the addition of, and/or the elimination of some terms or structures of that model. In some embodiments the indication of the presence of nonlinearity may be inferred by the continuing presence of significant nonlinear terms in a single nonlinear model after that model is optimized.

The use and comparison of the linear and nonlinear models or of linear and nonlinear terms within a single model, and the fact that data from arbitrary sensors on a structure can be successfully treated like proxy-input signals are both novel features of this invention.

### BRIEF DESCRIPTION OF THE DRAWINGS

FIG. 1 shows the apparatus of the invention. Broken lines are used to signify optional connections and optional elements that are not required for certain embodiments.

FIG. 2a-2b illustrates two respective embodiments of a linear stage.

FIG. 3a-3f illustrates several respective embodiments of a nonlinear stage.

FIG. 4 is a diagram of a five stage nonlinear model approximating the dynamics of a localized nonlinearity in a spatially extended system that is otherwise linear.

FIG. 5 is a simplified version of the nonlinear model depicted in FIG. 4 in which the feedback stage E has been eliminated.

FIG. 6 is not part of the invention, but rather shows the locations of sensors on a test setup that was used to generate data that was used to demonstrate the successful functioning of the invention. Location of the sensors is of no importance other than to understand this particular demonstration. Other structures may have different sensor locations and may use different types of sensors.

FIG. 7 is a table displaying the nonlinear Power Fraction, Γ_{N}, obtained for various bolt conditions from the experimental test setup used to test the functioning of the invention.

### DETAILS OF SOME EMBODIMENTS

The material in this section contains a considerable number of mathematical expressions. These are necessary in order to insure that the apparatus and method are fully reduced to practice. The discussion includes what the inventor has thus far found to be the two most preferred embodiments of the invention, each of which has desirable features that could be of primary importance for certain applications. However, as will become clear below, there are many possible embodiments of the invention, especially in terms of exactly how to express the linear and nonlinear models upon which method depends and how to reduce the results to a measure of possible structural damage. Variations of this kind, even if found to produce better results, should be considered to be other embodiments of this invention, not new inventions.

In order to utilize this method, it is necessary to have available at least two time series data sets sampled simultaneously at different locations on the system of interest. As mentioned previously, a time series is just a sequence of numbers, typically obtained by periodically measuring some variable like strain at some location on a structure. Normally there will be a fixed time-step between measurements, e.g. once every 0.5 milliseconds. Optionally, any time series used in this analysis could be preprocessed in some way, e.g. by passing it through a digital filter. Optionally, one or more of these time series could represent the undistorted ambient or applied vibrations, but such data is not required. The method involves the use of a nonlinear model containing adjustable parameters, which uses one (or possibly more) of the available time series, rₙ, as input(s), and in which the setting of the parameters is based, at least in part, on finding an optimal fit between the time series output (or outputs) of this model and another one (or possibly more) time series, sₙ, which we have chosen to be the target(s).

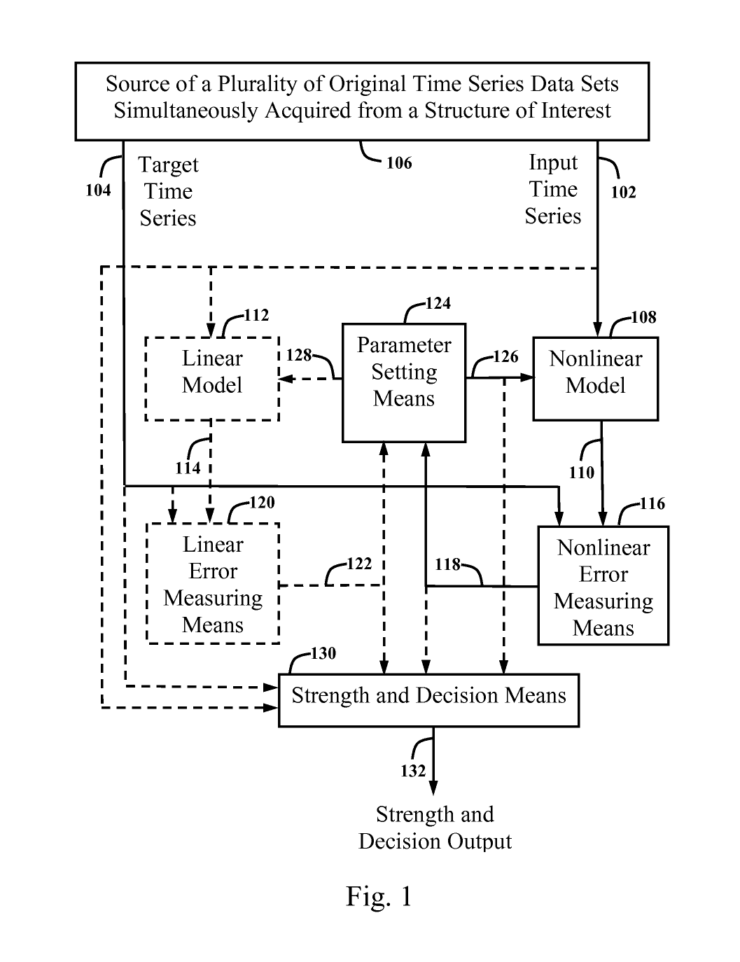

The apparatus of the invention is shown in FIG. 1. Elements and connections marked with dashed lines are optional and apply only to certain embodiments as explained below. FIG. 1 is for the case where there is a single input time series 102 and a single target time series 104, but can be easily generalized for multiple inputs or multiple targets if desired. These are to be selected from a source 106 of a plurality of simultaneously acquired time series from a structure of interest. How to select these is up to the user. Typically these time series may be available from a variety of different locations on the structure, and some of these may be closer than others to a potential site of structural damage. Consequently, there may be an advantage to repeating the method of the invention using a variety of different choices for the input and target as this may improve the chances of successfully detecting nonlinear distortion and thereby identifying structural damage when it exists. The invention includes a nonlinear model 108 which processes the data from the input time series 102 and which produces an output time series 110. The nonlinear model is assumed to be dependent on a number of adjustable parameters, making it able to approximate the effects of a wide range of structural characteristics including those with structural damage. The invention optionally includes a linear model 112 which also processes the data from the same input time series 102 and which produces an output time series 114. The preferred embodiments include this linear model, but some alternate embodiments may not. The linear model is also assumed to be dependent on a number of adjustable parameters, making it able to approximate the effects of a wide range of structural characteristics, but unable to approximate the nonlinear effects that may occur if structural damage is present. When the optional linear model is not used, the nonlinear model must be separable into linear and nonlinear parts having separate adjustable parameters, so that it contains a linear model within a nonlinear model and is essentially performing both roles simultaneously. A nonlinear error measuring means 116 is provided, which performs a mathematical function on the nonlinear output time series 110 and the target time series 104 providing a nonlinear error measure output 118 that is a single number that represents the error in matching the nonlinear model output time series 110 to the target time series 104. When the optional linear model is present, a linear error measuring means 120 is also provided, which performs a mathematical function on the linear model output 114 and the target time series 104 providing a linear error measure output 122 that is a single number that represents the error in matching the linear model output time series 114 to the target time series 104. Typically the function used to calculate the nonlinear error measure is identical to the one used for the linear error measure, so it should be considered equivalent to have a single error measuring means that can be switched back and forth to perform both the linear and nonlinear functions. The parameters of the models being used are adjusted to their final values by a parameter setting means 124, which has an output 126 containing values for the parameters for the nonlinear model and for embodiments where the linear model is present, has an output 128 containing values for the parameters for the linear model. One way to accomplish this parameter setting is to seek parameter values that produce the minimum values for the error measures 118 and 122. However there are also other methods that can be used. For example, in cases where the linear model and the linear part of the nonlinear model are wholly or partially identical, the parameter setting means can also involve the transfer of optimized parameter values from one model to corresponding parameters of the other model. Following the setting of the parameters, a strength and decision means 130 is used generate an output 132 comprising of one or both of the following: (1) a number that represents the strength of the detected nonlinearity which may indicate a potential strength of some associated structural damage and (2) a yes or no decision as to whether or not the results would indicate a significant likelihood of structural damage. Typically (2) would be produced from (1) by setting a yes/no threshold for the strength measure which lies above some anticipated background nonlinearity. For embodiments where the optional linear model is present, the nonlinearity strength may typically be obtained from the difference between the linear and nonlinear error measures, possibly normalized by dividing by an appropriate statistical property of the target time series 104 such as the variance. In alternate embodiments where the linear model is not used, the results might typically be obtained by examining the size of the parameters associated with the linear and nonlinear terms in the model, possibly in relation to some statistical measures obtained from the input time series 102 and from the target time series 104. Note that although all of the inputs shown for the strength and decision means 130 are marked as optional with dashed lines, at a minimum it must be coupled to receive either the nonlinear error measure 118 or the nonlinear parameter values 128.

Although not required by the method, it is often advantageous to break down the nonlinear model into a network of “stages”, each of which is a function that takes a time series input and produces a time series output. A stage may depend on a number of adjustable parameters. Unlike the full model, it will normally be assumed not to contain any internal structure or hidden variables. Typically a model containing one or more nonlinear stages will be nonlinear. A linear model can also be represented as a network of stages, and this is particularly useful in the case where the linear model is generated by “linearizing” a nonlinear model. Linearizing is most easily accomplished when a model has very distinct nonlinear terms that can be turned off within the stages that comprise it, leaving only linear terms which will result in a linear model. Stages can be linear or nonlinear and they can be memoried or memoryless. The goal is to make a good model out of a number of stages that requires less total parameters than an equivalent single stage model. This can be achieved by using the linear stages to take care of the memoried aspects of the structural dynamics, allowing for a simpler representation of the nonlinear aspects of the dynamics in nonlinear stages with little or no memory. Stages can be connected in series, which means that the output of one stage becomes the input for the subsequent stage. Stages can be connected in parallel, which means that they share a common input time-series and that the corresponding elements of their respective output time-series are added (or otherwise combined) together to produce the combined output time series. Adding can be accomplished using a multiple input “adder stage”, whose output is the sum of all of the inputs. Outputs should not be connected directly together. A stage can be used as a “feedback stage” when it is hooked up to other stages in such a way that the output of the feedback stage can influence the value of its future inputs.

It is also straightforward to create models or stages within models which depend on more than one input time series and/or generate more than one output time series. Since this is likely to increase the number of adjustable parameters that must be determined, this should only be done if it results in a significant improvement in the performance. An exception is the use of an adder stage as mentioned previously. Normally an adder stage will have no adjustable parameters unless it is desired to create a weighted combination of the inputs to the adder. A simple adder without parameters will be represented by a box with a plus symbol, having two or more inputs indicated by incoming arrows and one output. To simplify the discussion the linear and nonlinear models will be assumed to have one input and one output. This is easy to change if desired.

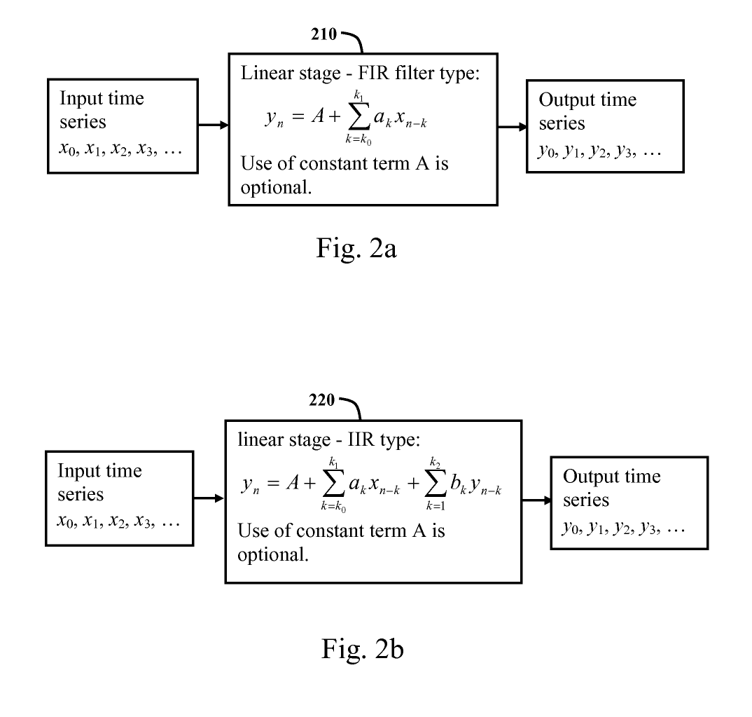

Two typical linear stages are shown in FIG. 2. In FIG. 2a is shown what is commonly known as a finite impulse response (FIR) filter. The defining function 210 has an input time series xₙ, an output time series yₙ and depends on adjustable parameters aₖ and an optional constant term A. There is also an index offset k₀. The total number of terms in the sum is sometimes referred to as the number of “taps”. Note that in the conventional use of a FIR filter its parameters are chosen in order to achieve a desired filtering effect, usually to suppress or intensify certain frequencies in a time series in a predetermined way. Here we are using the concept in reverse: the physical structure from which the data is collected is acting like an unknown filter on the vibrations passing through it, and we are trying to approximately duplicate this filtering effect with our model through careful setting of the adjustable parameters. If the physical structure is purely linear, a single stage model using a FIR filter can often do a fairly good job of duplicating this filtering effect. In FIG. 2b we add additional terms allowing dependence of the output on previous elements of the output time series, obtaining another type of linear stage commonly known as an infinite impulse response (IIR) filter. It is defined by the function 220 which now has the additional parameters bₖ. Because of the feedback nature of these new terms, this stage has very long term memory, far beyond the range of input values. It also needs to be initialized, since at the starting point the needed previous output values will be unknown. Usually we will simply set the previous values initially to zero and process the stage a certain number of initializing steps into the future before using the output.

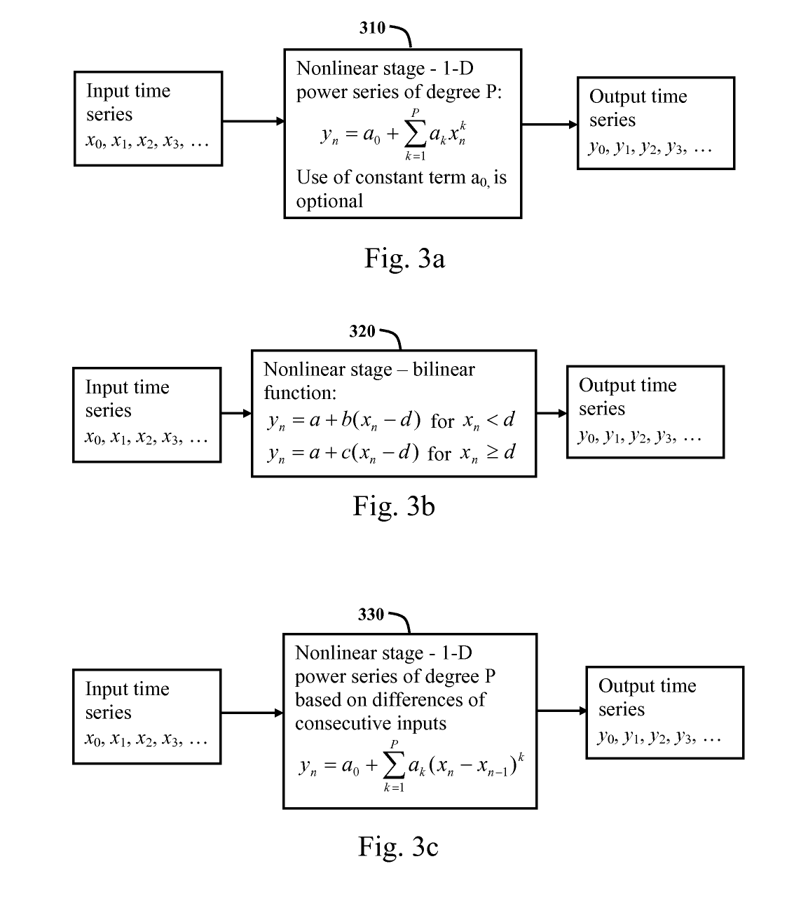

Some typical nonlinear stages are shown in FIG. 3. In FIG. 3a is shown a memoryless power series of degree P 310 that depends on a set of adjustable parameters aₖ. This is a one-dimensional (1-D) stage, meaning that each output yₙ depends only on a single input xₙ. This is often a good choice for a nonlinear stage within a model since it typically has a very small number of terms and yet may do a good job of characterizing a localized nonlinearity by itself, outside of the environment of the larger structure. In FIG. 3b is shown a bilinear function 320 which depends on four adjustable parameters a, b, c and d. This is also a 1-D function. It appears linear over a range of input values, but the slope or proportionality factor changes when the input xₙ, exceeds a threshold value d. This may be useful for modeling certain types of nonlinearities such as those generated by a crack in a structure where forcing in one direction may open the crack in a proportional way while forcing in the opposite direction may clamp it shut. The threshold is the point of transition between these two types of behavior. FIG. 3c illustrates a differencebased 1-D nonlinear function 330 that may characterize the nonlinear stage. This nonlinear stage embodiment may be selected for use as an alternative to the function 310 for correction of slew-rate related nonlinearities. The nonlinear stage may be implemented according to the general 1-D function 340 illustrated in FIG. 3d, depending on a number of parameters. This case would include other types of series expansions that might have advantages for particular applications and also would include spline or other methods of directly approximating the shape of a nonlinear function. In the nonlinear stage embodiment illustrated in FIG. 3e, the characterizing function 350 may be implemented as a 2-D power series for nonlinearities that cannot be reduced to 1-D such as might depend simultaneously on amplitude and slew rate. This is the most likely embodiment where the function depends on two consecutive input values. The nonlinear stage embodiment of FIG. 3f is characterized by a general function 360 in D-dimensions. The desirability of this embodiment decreases as D increases, as the number of adjustable parameters needed to make such a stage completely general increases dramatically with increasing D.

Note that when using any of these defined stages as a building blocks for the creation of a model, the names of the input and output variables as well as the names of the adjustable parameters may be renamed as desired, and often such renaming is required. When the output of one stage is connected to the input of another stage the names of the associated variables should be the same and this will typically require changing at least one of them. Conversely, inputs and/or outputs that are not connected should have associated variables with different names. Usually the parameters in separate stages should have different names. The names of variables used as subscripts and used in summations over may be changed as desired or may have offsets added to them. This renaming process is demonstrated below where some preferred embodiments for the nonlinear model are described and constructed from the stages just described.

An error measure M is needed to quantify the fit of the output time series zₙ from a model (either the linear or the nonlinear one) to the target time series sₙ. The model will be a function of a number of parameters and can therefore be written zₙ(\vec{θ}), where \vec{θ} is an array of numbers representing the parameter values. Defining the error time series qₙ(\vec{θ})=zₙ(\vec{θ})−sₙ, one choice of error measure is the variance of qₙ(\vec{θ}) (the variance being a well known statistical measure):

$$M ( \vec{θ} ) = \frac{1}{N - 1} [ {\sum }_{k = 0}^{N - 1} {{q}_{k + {k}_{s}} ( \vec{θ} )}^{2} - \frac{1}{N} {( {\sum }_{k = 0}^{N - 1} {q}_{k + {k}_{s}} ( \vec{θ} ) )}^{2} ] \qquad ( 1 )$$

where kₛ is the starting index and N is the number of points to be included. Under the assumption that the corrupting noise on the measurements is independent and identically distributed (iid) Gaussian, minimization of Equation (1) gives a maximum likelihood estimate of the model parameters \vec{θ}. Note that M(\vec{θ}) could be expressed as a mean square error rather than an error variance, but use of the variance will, in many cases, eliminate the need for constant coefficients in the stages described below. Other choices for M are also possible, and all should be considered to be alternate embodiments for use in this invention. Use of the above formula to calculate the error measure for the nonlinear model used in the invention defines an embodiment of the nonlinear error measuring means. Use of the above formula to calculate the error measure for the linear model used in the invention defines an embodiment of the linear error measuring means.

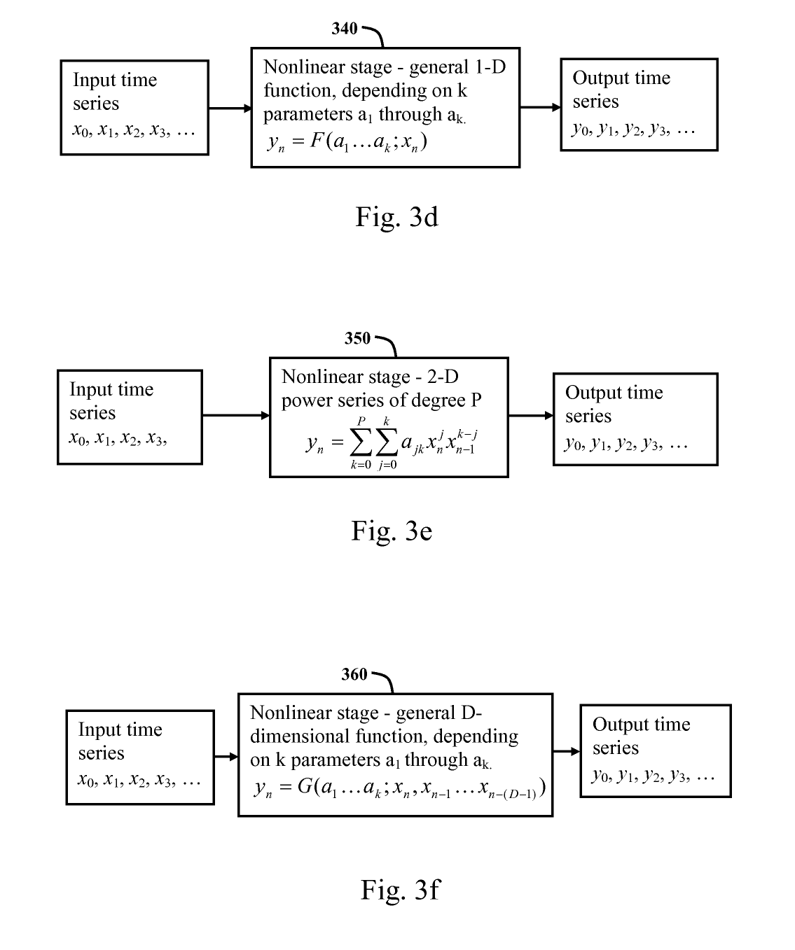

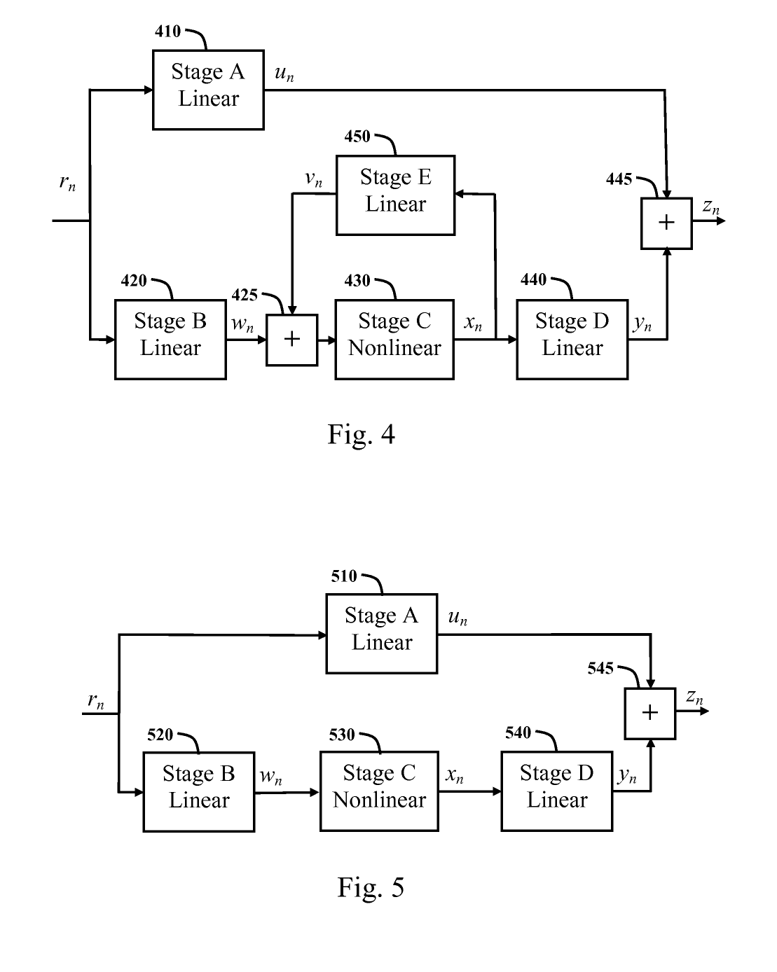

One embodiment for the nonlinear model is shown in FIG. 4. It consists of four linear stages (410, 420, 440 and 450) and one nonlinear stage 430. The linear stages are memoried, while the nonlinear stage is either memoryless, or possibly of very limited memory. This embodiment can be shown to be a good model for a localized nonlinearity in a spatially extended system that is otherwise linear (see “Modeling and detecting localized nonlinearity in continuum systems with a multistage transform”, by P. H. Bryant and J. M. Nichols, Phys. Rev. E, Vol. 81, 026209, published 19 Feb. 2010, incorporated herein by reference). Note that stage E 450 provides feedback from the output of the nonlinear stage back to its input. Experimental results are given for the operation of this embodiment of the nonlinear model and also for another embodiment in which the feedback stage has been omitted as shown in FIG. 5. Now the output of stage B 520 is connected directly to the input of stage C 530, and the adder 425 that formerly connected to the input of stage C 430 is eliminated. As will be discussed, each of these embodiments has advantages. It is expected that the nonlinear model will probably function with other modifications, for example by eliminating various combinations of linear stages. For this test of the invention, the linear stages were all embodied in the form of FIR filters 210 as shown in FIG. 2a, and the nonlinear stage was embodied in the form of a memoryless power series 310 as shown in FIG. 3a, i.e. with no dependence on previous time steps. When the feedback stage 450 is included, the model potentially has very long term memory because of the feedback loop. For this reason, the corresponding linear model was chosen to be the exact same model but with a linearized nonlinear stage C 430. This is to avoid giving the nonlinear model any advantage in modeling linear systems. Ideally both models should have identical capabilities in regards to linear structures, so that any differences correspond to the presence of nonlinearity in the structure. Since the nonlinear stage C is a power series, all that is necessary to linearize it is to eliminate all the higher powers above the first power. When testing the embodiment where the feedback stage is omitted, there is no long term memory, provided we use FIR filters and not IIR filters for the linear stages. This gives us the option of using a single FIR filter for the linear model, provided that it is chosen to accept at least the same temporal range of input values as required by the nonlinear model to produce any particular output value. It is convenient in that case to choose stage A 510 of the nonlinear model to be identical to the linear model.

We will now present in detail an embodiment of the nonlinear model that incorporates the feedback stage 450 as shown in FIG. 4 and also an embodiment that omits it as shown in FIG. 5. Note that more than one embodiment is possible for the structures shown in each of these two figures since the stages of which they are comprised can be embodied in a variety of ways. One such embodiment for each of the two figures is described below. In the description, the embodiments are referred to as the embodiment with feedback, the embodiment without feedback or both embodiments. Following the description is given some experimental results from a test structure demonstrating the operation of the invention for these two embodiments. Reference numbers from both figures are given where appropriate. To make the implementation clear, the equations for the various stages are given with the variable names changed appropriately from those given in FIGS. 2a and 3a.

For both embodiments, stage A (410 and 510) is a FIR filter:

$${u}_{n} = {\sum }_{k = 0}^{{D}_{A} - 1} {a}_{k} {r}_{n - k + {k}_{A}} \qquad ( 2 )$$

where aₖ is set of adjustable coefficients and k_{A} is an offset for the index of the input time series rₙ. The number of terms in the sum over k is equal to the number of taps of the filter, which in this case is D_{A} Note that we made a slight change from the form given for a FIR filter 210 in FIG. 2a in that the offset is included in the subscript of r instead of the lower limit of the summation which now starts at zero. This form is entirely equivalent to the one given previously.

For both embodiments, stage B (420 and 520) is again a FIR filter:

$${w}_{n} = {\sum }_{k = 0}^{{D}_{B} - 1} {b}_{k} {r}_{n - k + {k}_{B}} \qquad ( 3 )$$

where bₖ is set of adjustable coefficients, D_{B} is the number of taps and k_{B} is an index offset which may be different from k_{A}. Note that if we wanted to make the model depend on more than one input time series, we can simply add an additional summation on the right hand side of this and the previous equation, to sum over all input series. Each series would have a separate set of aₖ and bₖ coefficients and an extra subscript could be added to keep these distinct, i.e. as a_{i,k} and b_{i,k}.

For both embodiments stage C 430 is a memoryless power series, however for the embodiment with feedback it is convenient to combine it with the adder stage 425 to obtain:

$${x}_{n} = {\sum }_{k = 1}^{P} {{c}_{k} ( {w}_{n} + {v}_{n} )}^{k} \qquad ( 4 )$$

where cₖ is set of adjustable coefficients, vₙ is the output of the feedback stage E 450, and P is the maximum power to be used. The function of the adder stage 425 is represented by the plus symbol in the above equation. For the embodiment without feedback one obtains the slightly simpler form for stage C 530:

$${x}_{n} = {\sum }_{k = 1}^{P} {c}_{k} {w}_{n}^{k} \qquad ( 5 )$$

Note that in alternate embodiments one could choose to include only certain powers, such as odd or even which could be useful when there is a symmetry to the anticipated nonlinearity. In some cases one might wish to use a weakly memoried nonlinear stage that depends on a small number of previous time steps. Certain types of nonlinear stages might require an input biasing coefficient. The power series (with no missing powers) will not need a bias, as such a bias could be absorbed by suitable coefficient changes.

For both embodiments, stage D (440 and 540) is approximated as another FIR filter:

$${y}_{n} = {\sum }_{k = 0}^{{D}_{D} - 1} {d}_{k} {x}_{n - k} \qquad ( 6 )$$

where dₖ is set of adjustable coefficients and D_{D} is the number of taps. No index offset is needed here since this stage is in series with stage B and the offset k_{B} was included there.

The optional linear feedback stage E 450 may be important in cases where delayed self-interaction of the nonlinear component plays a significant role. For the embodiment with feedback, a FIR filter form is again used:

$${v}_{n} = {\sum }_{k = 1}^{{D}_{E}} {e}_{k} {x}_{n - k} . \qquad ( 7 )$$

where eₖ is set of adjustable coefficients and D_{E} is the number of taps. Note that we start the sum with k=1 to insure that this stage is strictly causal, i.e. depending only on the past and not on the present or future. Note also that stages C and E must be processed together one time step at a time so that the output of stage E will be available to the input of stage C. (A subtle point is that an instantaneous feedback corresponding to k=0 can actually be absorbed into a redefinition of the nonlinear function defining stage C, i.e. by a change in its adjustable parameters.)

The outputs of stages A (410 and 510) and D (440 and 540) are added together to produce zₙ the output of the model:

zₙ=yₙ+uₙ. (8)

The entire parameter vector for the nonlinear model includes aₖ, bₖ, cₖ, dₖ, eₖ and optionally the index offsets k_{A} and k_{B} as well. These parameters can be adjusted in order to minimize the error measure Eq. (1), bringing this generic nonlinear model as close as possible to representing the dynamics of the actual structure. The sampling rate, the maximum power of the nonlinear stage and the number of taps used in the linear stages must also be chosen, but here one must consider the trade-off between the complexity of the model and the accuracy of the result.

When a model depends nonlinearly on its coefficients as it does here, an optimization algorithm is needed. There are several good choices available including the Powell “direction set method” that discards the direction of largest decrease, the Brent variant of the Powell method, the BroydenFletcher-Goldfarb-Shanno (BFGS) “quasi-Newton method” with numerically determined derivatives, the Fletcher-Reeves conjugate gradient method, the Polak-Ribiere conjugate gradient method, the Nelder-Meade downhill simplex method and the simulated annealing method. See, e.g. “Numerical Recipes 3rd Edition: The Art of Scientific Computing” by Press et al., Cambridge University Press 2007, chapter 10, and “Algorithms for Minimization without Derivatives” by R. Brent, Prentice-Hall 1973, Chapter 7, both incorporated herein by reference. These are iterative methods—an initial set of values for the parameters must be supplied and the algorithm then systematically looks for a path through the parameter space that causes the supplied error measure to decrease. For the results given below for the experimental test, all parameter values were initialized to zero except b₀ and d₀ which were initialized to 1. Parameters for single stage models, linear or nonlinear, can be often be solved directly by the method of normal equations, provided the dependence of the output on the adjustable parameters is linear and that the error measure is either the variance or the mean square error. This is the preferred method for such cases. See, e.g. “Numerical Recipes 3rd Edition: The Art of Scientific Computing” by Press et al., Cambridge University Press 2007, chapter 15, incorporated herein by reference.

Nonlinear optimization problems like this can be susceptible to getting stuck in a local minimum, although this has not been a major problem for the tests of the invention. The embodiments with and without feedback use two different “means of parameter setting”. For the embodiment with feedback we first initialize all of the parameters of the nonlinear model to zero except b₀ and d₀ which we initialize to 1. (This initialization choice is not critical, many other choices are possible.) We then optimize the nonlinear model using the Powell method to find parameter values that minimize the error measure for that model. We then linearize the nonlinear model by eliminating the powers in the nonlinear stage C above the first power and use this linearized model for the linear model without further optimization. This constitutes one embodiment of the parameter setting means 124 of FIG. 1. When the data being analyzed is entirely linear, the optimization method is expected to end up with negligibly small values for the higher powers, making the linear and nonlinear models generate nearly identical error measures. Conversely, when nonlinearity in the data is captured in the nonlinear terms of stage C, the elimination of these terms will result in an increased error measure for the resulting linear model.

For the embodiment without feedback, there is no long term memory and it is possible to limit the temporal range of inputs needed by the nonlinear model to be confined to lie within the corresponding range of the linear model, which in this case is chosen to be a single stage identical to stage A of the nonlinear model. Referring to Eq. (2), the range of time index for the input required by stage A to generate the output for time index n is from n+k_{A}−(D_{A}−1) to n+k_{A}. Referring to Eqs. (3), (5) and (6), for the series combination of stages B, C and D which appear in the nonlinear model in parallel with stage A the corresponding range can be shown to be from n+k_{B}−(D_{B}−1)−(D_{D}−1) to n+k_{B}. Thus we require that k_{B}≦k_{A} and that k_{B}−(D_{B}−1)−(D_{D}−1)≧k_{A}−(D_{A}−1). This guarantees that the nonlinear model and the linear model will have identical capabilities in regards to modeling purely linear dynamics.

The first step for setting the parameters for the embodiment without feedback is to optimize the linear model by the method of normal equations. The calculated parameters from the linear model are then transferred to the identical stage A of the nonlinear model. It is helpful to then initialize the remaining parameters of the nonlinear model to values that will generate no contribution to the output so that initially the nonlinear model will perform identically to the linear model. Many choices are possible—the one made for this specific embodiment is to set all of the parameters in stages B, C and D to zero except for b₀ and d₀ which were set to 1. From that starting point, with stage A is held fixed, the parameters in stages B, C and D are optimized using the Powell method to try and further reduce the error measure below that which could be achieved by stage A alone. This constitutes a second embodiment of the parameter setting means 124 of FIG. 1. (A variant of this embodiment is to optimize all stages rather than holding stage A fixed.) This embodiment may have a greater immunity to false positive readings for nonlinearity since the solution of the linear model by normal equations is essentially an exact method, meaning that there should be no way that the nonlinear model can do better unless nonlinearity is actually present. On the other hand, the embodiment with feedback is a potentially more accurate and therefore more sensitive model for detecting low levels of nonlinearity. So each of these embodiments has some potential advantages.

The particular embodiment of the error measure as defined by Eq. (1), is essentially a mean square amplitude, and may in some cases be considered to be a kind of measure of the vibrational power of the signal it is based upon. (This would seem reasonable for the case of the strain measurements given in experimental results below.) After first selecting the parameters for the linear and nonlinear models, we are immediately presented with three quantities: the power, P_{O}, of the original target time series (i.e. the error measure with the model output set to zero), the residual power, P_{L}, when using the linear model and the residual power, P_{N} after using the nonlinear model. The fraction of the power removed by the linear model is:

Γ_{L}=(P_{O}−P_{L})/P_{O} (9)

and the additional fraction of power removed by using the nonlinear model instead of the linear model is the nonlinear power fraction:

Γ_{N}=(P_{L}−P_{N})/P_{O} (10)

Nonlinearity and possible damage is indicated when Γ_{N} goes up. If desired, it can be compared to some threshold value in order to provide a yes or no decision on whether structural damage is indicated. The threshold value would likely be determined by previous values obtained for Γ_{N} when the structure was known to be free of significant damage. The calculation of Γ_{N} and/or the decision on damage constitutes one embodiment of the strength and decision means 130 of FIG. 1. One alternate embodiment would attempt to calculate a strength of the nonlinearity directly from the nonlinear terms in the nonlinear model. In this embodiment there would be no need to evaluate a linear model at all. It would probably be somewhat less reliable, but nevertheless could likely be made to function to some degree for detecting structural damage.

In some cases there may be an interest in optimizing the performance of the model in the frequency domain for some particular range of frequencies. This can be accomplished by starting with the error time series, defined, as previously, as the difference between the output time series and the target time series, dividing it into groups of consecutive time-steps and performing a discrete fast Fourier transform on each group. One can then find the mean square amplitude for each frequency component by averaging the squared results over all groups in the full time series. The error measure M(\vec{θ}), previously defined by Eq. (1), can be redefined, for example, as a weighted sum of these mean square values, with the weighting adjusted to emphasize the frequencies deemed to be important to the detection of structural damage, and to deemphasize or eliminate contributions from other frequencies.

The experimental structure which was used to successfully verify the functioning of the invention is a composite beam measuring 1.219 m in length by 17.15 cm in width and 1.905 cm in thickness. The beam was bolted at both ends to two steel plates using 4×1.9 cm thick bolts measuring 8.9 cm length. Each of the bolts are Strainsert instrumented bolts capable of measuring axial force. The composite material utilizes a quasi-isotropic layup consisting of (0/90) and (+/−45) 24 oz. knit EGlass fabric. Excitation was provided by means of a MB Dynamics (PM50a) electrodynamic shaker, coupled to the mid-span of the beam through a thin aluminum rod. Between the rod and the beam is an Sensotec Model 31 load cell for recording the input signal. Note that the load cell interacts with the beam dynamics and thus is not a pure input signal.

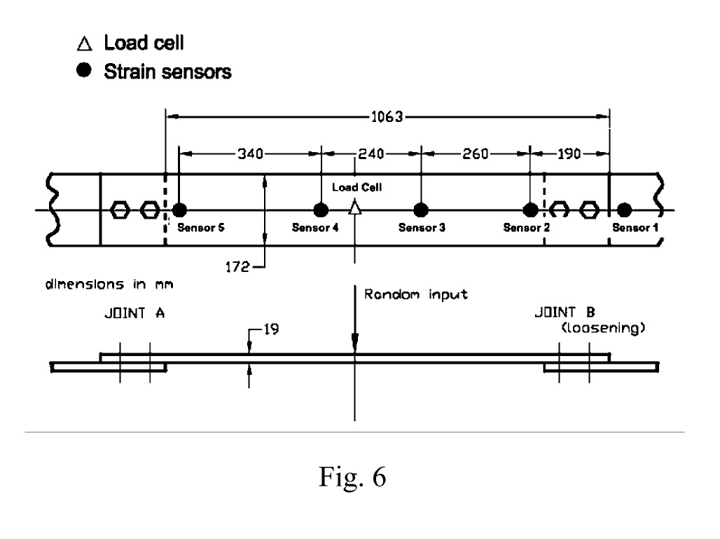

The vibrational response of the structure was measured at five separate locations on the beam, as shown in FIG. 6, at a data rate of 1951 Hertz using a fiber optic strain sensing system with fiber Bragg gratings (FBGs) as the sensing element. (Note that the information contained in FIG. 6 is only relevant to this particular test of the invention.)

In addition to the fully tightened state, data was analyzed from three “damaged states” involving the loosening of both bolts connecting one end of the composite to the steel: finger tight, small gap (the nut holding the bolt in place is loose but the bolt is still firmly held in the bolt holes), and large gap (the nut is loose and the bolts were loosened in the holes). The damage constitutes a localized nonlinearity in the following sense: at all other locations, the beam is characterized by a stiffness parameter that is approximately constant over the range of motion to which the system is subjected, but at the site of the loose bolts, the stiffness is dependent on bending. When the beam is unbent at that site, the bolts will be in a “slack” state and so the stiffness will be very small or zero. But when the beam is significantly bent in either direction at that site the bolts will engage and the stiffness will return to near its normal value. Thus the governing equations will only be nonlinear at that location.

In order to generate the response signals, 30 seconds of dynamic loading was applied and the structural response from all five FBGs was recorded as well as the excitation (using a load cell). The dynamic loading was chosen to conform to a random process described by the Pierson-Moskowitz frequency distribution for wave height in order to mimic the type of loading this component would be subject to on a ship structure.

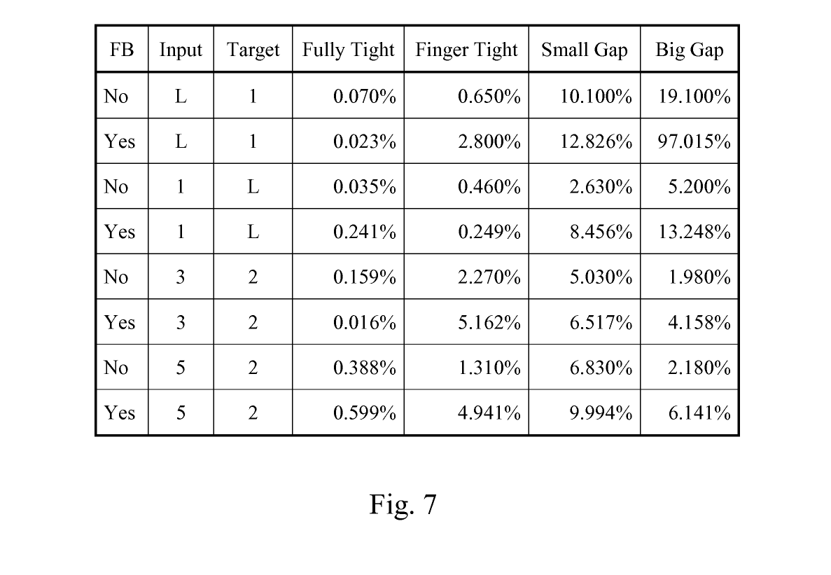

38400 data points were used as training data and 6400 as testing data. Results were obtained for both embodiments, i.e. with and without the feedback stage. A variety of input and target combinations were tried and also a variety of control parameters. In virtually all cases we could strongly detect the nonlinearity produced by the “big gap” and “small gap”. For most combinations we were also able to reliably detect the “finger tight” case. We ran some tests with k_{A}=k_{B}=0, D_{A}=39, D_{B1}=D_{B3}=20 and P=3, which requires a total of 82 adjustable coefficients. Results are given in FIG. 7, which is a table showing the nonlinear power fraction, Γ_{N}, obtained for various bolt conditions. Other than the fully tight case, these represent varying degrees of damage. Columns labeled Input and Target list the sensor numbers from which the corresponding time series were taken (with L used to represent the load cell output). The column labeled FB indicates whether or not the feedback stage E was used. Note that nearly all results for the “damaged” cases are significantly more nonlinear than the fully tight case, i.e. the damage has been successfully detected by the analysis. In the first case, we used the load cell as the input and sensor 1 as the target. The dramatic increases in Γ_{N} compared to the fully tight result clearly identifies all of the loose bolt trials, including finger tight, as nonlinear and therefore as probably damaged. Switching the input and target we again can clearly identify the nonlinearity including the difficult finger tight case. Note that some configurations have a higher background nonlinearity (the tight result) than others—this does not appear to be noise, but rather an unknown source of nonlinearity, possibly some slight beam damage or a defect in the sensors. The last two cases, which use sensor 2 as the target, show a smaller response to the big gap than to the small gap. One possible explanation is that the nonlinear signal is weak at some locations and strong at others, and that these locations change with gap size. The ability to detect the damaged state appears to be at least as good and potentially better than the surrogate method used in “Using Ambient Vibrations to Detect Loosening of a Composite-to-Metal Bolted Joint in the Presence of Strong Temperature Fluctuations”, by J. M. Nichols et al., Journal of Vibration and Acoustics 2007, vol. 129, pp. 710-717, previously incorporated herein by reference, which examined data from the same experimental system.

I claim:

1. An apparatus for detecting structural damage through the analysis of vibrational data comprising:
a source of a plurality of original time-series data sets simultaneously acquired from sensors located on or near a physical structure, with one or more of the data sets currently designated as inputs and one or more of the data sets currently designated as targets;
a nonlinear model with adjustable parameters, constructed to accept one or more input time-series and to produce one or more output time-series, coupled to receive the one or more input time-series from the original time-series data sets, and with each of the output time-series being associated with a particular one of the target time-series from the original time-series data sets, and with an input for setting the adjustable parameters;
nonlinear error measuring means for producing an error measure which quantifies the difference between the one or more output time-series of the nonlinear model and the corresponding one or more target time-series, coupled to receive the time series output from the nonlinear model and to receive the target time series from the original time series data sets;
optionally a linear model with adjustable parameters, constructed to accept the same number of input time-series as the nonlinear model and to produce the same number of output time-series as the nonlinear model, coupled to receive the same one or more input time-series as those coupled to the nonlinear model, and with the one or more output time-series being associated with the same set of target time-series data sets as the nonlinear model, and with an input for setting the adjustable parameters;
when the optional linear model is present, a linear error measuring means for producing an error measure which quantifies the difference between the one or more output time-series of the linear model and the corresponding one or more target time-series, coupled to receive the time series output from the linear model and to receive the target time series from the original time series data sets and typically using the same mathematical function to calculate the error measure as is used by the nonlinear error measuring means;
parameter setting means, for setting values for the parameters in the nonlinear model and also in the optional linear model when it is present, through optimization processes designed find the parameter values that minimize an error measure, except that when the linear model is present, optionally some parameters may be set by transferring the values of parameters that have been set in one model to corresponding parameters in the other model, coupled to receive an error measure from the nonlinear error measuring means and optionally also from the linear error measuring means when it is present, and coupled to transmit parameter values to the nonlinear model and to the linear model when it is present;
strength and decision means, for generating a strength measure for non-linearity detected by the invention and optionally to decide if the detected strength is sufficient to indicate that structural damage is likely, coupled to receive, when the optional linear model is present, the linear error measure from the linear error measuring means, coupled to to receive, when the optional linear model is present, the nonlinear error measure from the nonlinear error measuring means, optionally coupled to receive, when the optional linear model is present, the target time series from the original time series data sets, coupled to receive, when the optional linear model is absent, the nonlinear parameter values from the parameter setting means, optionally coupled to receive, when the optional linear model is absent, the input time series from the original time series data sets and optionally coupled to receive, when the optional linear model is absent, the target time series from the original time series data sets.

2. The apparatus of claim 1 wherein the nonlinear model is comprised of a plurality of stages connected in a network including at least one linear stage and at least one nonlinear stage.

3. The apparatus of claim 2 wherein the network is comprised of a first stage that is a linear stage and whose input is connected to the input of the nonlinear model, a second stage that is a linear stage and whose input is connected to the input of the nonlinear model, a third stage that is a nonlinear stage and whose input is connected to the output of the second stage, a fourth stage that is a linear stage and whose input is connected to the output of the third stage, and an adder stage whose two inputs are connected respectively to the output of the first stage and the output of the fourth stage and whose output is the output of the nonlinear model.

4. The apparatus of claim 2 wherein the network is comprised of a first stage that is a linear stage and whose input is connected to the input of the nonlinear model, a second stage that is a linear stage and whose input is connected to the input of the nonlinear model, a third stage that is a nonlinear stage, a fourth stage that is a linear stage and whose input is connected to the output of the third stage, a fifth stage that is a linear stage and whose input is connected to the output of the third stage, a first adder stage whose two inputs are connected respectively to the output of the first stage and the output of the fourth stage and whose output is the output of the nonlinear model and a second adder stage whose two inputs are connected respectively to the output of the second stage and the output of the fifth stage and whose output is connected to the input of the third stage.

5. The apparatus of claim 1 with the optional linear model included, wherein the linear model is in the form of a finite impulse response filter and nonlinear model is a parallel combination of a copy of the linear model and a nonlinear sub-model, the sub-model having a temporal input range needed to calculate the output for a given time step confined to lie within the corresponding range of the linear model, whereby the linear and nonlinear models have identical ability to model data from a purely linear structure which is beneficial in preventing false positives for nonlinearity.

6. The apparatus of claim 5 wherein the parameter setting means comprises minimizing the error measure of the linear model using a first optimization method to adjust the parameters of that model, substituting the parameter values so obtained into the copy of the linear model that is contained within the nonlinear model, and attempting to further reduce the error measure of the nonlinear model using a second optimization method to adjust the parameters of that model, optionally while holding fixed the parameters of the linear model that is contained within it, whereby such further reduction, if significant, may indicate nonlinear distortion and structural damage.

7. The apparatus of claim 1 with the optional linear model included, wherein the nonlinear model or the stages of which it is comprised can be broken down into linear and nonlinear terms, and wherein the linear model is generated by making a copy of the nonlinear model and eliminating all of the nonlinear terms.

8. The apparatus of claim 7 wherein the parameter setting means uses an optimization method to find parameter values that minimize the error measure of the nonlinear model and then copies the values of the parameters associated with the linear terms within the nonlinear model to the corresponding parameters in the linear model.

9. The apparatus of claim 3 wherein the linear stages are finite impulse response filters.

10. The apparatus of claim 3 wherein the nonlinear stage is a memoryless 1-D power series.

11. The apparatus of claim 6, wherein the first and second optimization methods are each selected from the group consisting of the Powell direction set method that discards the direction of largest decrease, and Brent's variant of the Powell direction set method and the Broyden-FletcherGoldfarb-Shanno (BFGS) “quasi-Newton method” with numerically determined derivatives, and the Fletcher-Reeves conjugate gradient method and the Polak-Ribiere conjugate gradient method and the Nelder-Meade down-hill simplex method of and the simulated annealing method, and the normal equations method.

12. The apparatus of claim 1 wherein the nonlinear error measuring means and also the linear error measuring means when it is present, obtain their respective error measures by calculating the variance of the difference between the corresponding output time series and the target time series, the variance being a standard statistical measure.

13. The apparatus of claim 1 wherein the linear and nonlinear error measuring means calculate their respective error measures in the frequency domain, typically by taking the fast Fourier transform of the difference between the corresponding output time series and the target time series, and weighting the contributions of the resulting frequency components to the error measure according to the relative importance of those frequencies to the indication possible of structural damage.

14. The apparatus of claim 12 with the optional linear model included, wherein the strength and decision means obtains a strength output by calculating the nonlinear power fraction which is obtained by subtracting the nonlinear error measure from the linear error measure and dividing the result by the variance of the target time series.

15. The apparatus of claim 14 wherein the strength and decision means makes a decision as to whether or not damage is indicated by the results based on whether or not the strength output is above a predetermined threshold or background value, said threshold or background value possibly based on previous results obtained when the physical structure was known to have no significant damage.

16. A method for detecting structural damage through the analysis of vibrational data comprising:
providing one or more time series data sets designated as inputs and providing one or more time series data sets designated as targets;
providing a nonlinear model with adjustable parameters, constructed to accept one or more input time-series and to produce one or more output time-series, coupled to receive the one or more designated input time-series, and with each of the output time-series being associated with a particular one of the designated target time-series, and with an input for setting the adjustable parameters;
providing a nonlinear error measuring means for producing an error measure which quantifies the difference between the one or more output time-series of the nonlinear model and the corresponding one or more target time-series, coupled to receive the time series output from the nonlinear model and to receive the target time series from the original time series data sets;
optionally providing a linear model with adjustable parameters, constructed to accept the same number of input time-series as the non-linear model and to produce the same number of output time-series as the nonlinear model, coupled to receive the same one or more designated input time-series as those coupled to the nonlinear model, and with the one or more output time-series being associated with the same set of designated target time-series data sets as the nonlinear model, and with an input for setting the adjustable parameters;
when the optional linear model is present, providing a linear error measuring means for producing an error measure which quantifies the difference between the one or more output time-series of the linear model and the corresponding one or more target time-series, coupled to receive the time series output from the linear model and to receive the target time series from the original time series data sets;
setting the parameter values for the nonlinear model and also for the optional linear model when it is present, by optimizing some or all of the adjustable parameters with the objective of minimizing the associated error measure or error measures, then optionally transferring the values of some or all of the parameters that have been set within either the linear or nonlinear model to corresponding parameters within the other model and then optionally further optimizing some or all of the parameters;
generating a strength measure for nonlinearity detected by the invention and optionally deciding if the detected strength is sufficient to indicate that structural damage is likely by comparing the generated strength to some threshold value, the strength measure being determined, when the optional linear model is present, from the difference in the linear and nonlinear error measures or by some function of these two measures, and being determined, when the linear model is absent, from the parameter values of the nonlinear model, the nonlinear model or the stages of which it is comprised in that case being required to be separable into linear and nonlinear terms so that the relative strength of the parameters associated with the nonlinear terms may be determined.
